(19) United States
(12) Patent Application Publication
(10) Pub. No.: US 2021/0308600 A1
(43) Pub. Date: Oct. 7, 2021

(54) SILICONE DEFOAMER COMPOSITION AND METHOD FOR PRODUCING SILICONE DEFOAMER COMPOSITION BY ADJUSTING THE DISTRIBUTION WIDTH OF A ZETA POTENTIAL

(71) Applicant: Wacker Chemie AG, Munich (DE)

(72) Inventors: Satoshi Ohno, Chikusei-shi Ibaraki (JP); Kenji Igarashi, Chikusei-shi Ibaraki (JP)

(73) Assignee: Wacker Chemie AG, Munich (DE)

(21) Appl. No.: 17/268,105

(22) PCT Filed: Jul. 23, 2019
(86) PCT No.: PCT/EP2019/069835

§ 371 Date: Feb. 12, 2021

(30) Foreign Application Priority Data
Aug. 15, 2018 (JP) 2018-152880

(51) Int. Cl. B01D 19/04

(52) U.S. Cl. CPC B01D 19/0409

(57) ABSTRACT

A silicone defoamer composition of a type which defoams by being previously added to a foaming liquid includes a composite particle group of an oil containing silicone and silica.

### CROSS-REFERENCE TO RELATED APPLICATIONS

This application is the U.S. National Phase of PCT Application No. PCT/EP2019/069835 filed on Jul. 23, 2019, which claims priority to Japanese Application No. 2018-152880 filed Aug. 15, 2018, the entire disclosures of which are hereby incorporated by reference.

### BACKGROUND

The present invention relates to a silicone defoamer composition in which the distribution width of a zeta potential is set, and more particularly, to a silicone defoamer composition having excellent defoaming properties against various types of foam and a method for producing the same.

Defoamers are widely used in foaming-related processes such as in the chemical, food, petroleum, yarn making, textile, and pharmaceutical industries. Silicone has a low surface tension, and thus potentially possesses a defoaming ability. Also, silica is known to possess a foam-breaking action. Therefore, defoamers containing both silicone and silica are widely used. A silicone-based defoamer is classified into seven types, which are oil, compound, solution, emulsion, self-emulsification, powder, and solid. The compound-type defoamer is sometimes referred to as an oil compound in the defoamer industry.

There are two types of defoamers. One is a defoamer of the type to be previously added in a foaming liquid. The other is a defoamer of the type to be employed after a foaming liquid has foamed. Among these two defoamers, the defoamer of the type to be previously added in a foaming liquid is in the mainstream. This type of defoamer is further classified into two types. One is to suppress foam (that is, to prevent the formation of foam or suppress the formation of foam to a minimum) by previously dissolving polyether-modified silicone or the like in a foaming liquid or pouring a mineral oil or the like in a foaming liquid to form an oil film on the liquid surface for reducing the interfacial tension of a foaming liquid. In this case, a large amount of the defoamer needs to be used. In addition, the use of the large amount of the defoamer changes the quality of a foaming liquid, leading to an increased environmental load of drainage water. The other is mainly to previously add a composite particle of silicone and silica to a foaming liquid for causing the interfacial tension reducing function of silicone and the foam-breaking effect by silica, and exhibits a foam breaking action when foam is formed. Although a foam-suppressing action is estimated to be also exerted, the effect has not been sufficiently demonstrated. Since the required use amount of this type of defoamer is small, and the quality of the foaming liquid hardly changes, the use of this type of defoamer is most common. On the other hand, the defoamer of the type to be employed to a foaming liquid in which foam has been already formed is applied by spraying or the like. In this case, the foam is broken by either a physical action or an interfacial tension reducing action. In this case, the foam may be effectively temporarily broken in some cases, but defoaming persistence and a foam-suppressing action are often not exhibited.

Therefore, the defoamer of the type to previously add the composite particle to a foaming liquid is most common, and performs defoaming mainly by the foam-breaking action.

For serving as a defoamer, the composite particle needs to exist near a foam film. For dramatically enhancing dispersibility in water, the most effective form of a defoamer is an emulsion. Therefore, the emulsion-type silicone defoamer is most widely used. A defoamer as a compound which is in a solid state is also widely used, because it can be quickly dispersed in a foaming liquid.

The defoaming performance of a defoamer often depends on a foaming liquid. In some cases, defoaming performance was excellent for a certain foaming liquid, while insufficient for another foaming liquid. Therefore, a conventional defoamer as a defoamer composition has been designed according to only an empirical rule based on individual defoaming cases. In addition, when a defoamer for a separate foaming liquid is developed, the separate foaming liquid was necessary to be acquired in each case. Moreover, the development of a defoamer is largely based on past experiences or trial and error by engineers. Accordingly, a lengthened development period and an increased loss of manpower and cost were problematic in some cases. Since the defoaming performance of the same defoamer composition often varied by delicate differences in the production method, condition, and batch, a performance intended as a defoamer was frequently not exhibited.

The mainly used silicone defoamer that is of the type to be previously added to a foaming liquid and includes a composite particle of silicone and silica also possesses a foam-suppressing action. However, the foam-suppressing action is not sufficient. Thus, foaming is caused, and the foam is broken. Therefore, trial and error for exhibiting stable defoaming performance is difficult.

For solving these problems, there is a demand for the establishment of a method for theoretically and quantitatively designing, evaluating, and producing a defoamer which widely and stably exhibits a defoaming property for various types of foams. Furthermore, there is a demand for a defoamer which widely and stably exhibits a defoaming property for various types of foams.

As a countermeasure to this, for example, the author of J. Phys. Chem., 54 (3), 429 (1950) proposes the so-called Ross Theory that foam-breaking occurs when an interface free energy change (E) at the intrusion of a defoamer into a foam film and an interface free energy change (S) at the expansion are both negative, based on the premise that a decreasing direction is positive.

However, E, S>0 is a determination whether the arrangement when a defoamer enters a foam film and the arrangement when expands on a foam film are desirable or not as an equilibrium state, and does not estimate on what time scale it occurs. Therefore, even if a defoamer is designed so as to satisfy the condition of Ross theory, the intrusion and expansion can take a long time, and the defoamer may not be usable as a practical defoamer. Furthermore, when a specific raw material is selected from substantially identical raw materials, a guideline for the selection cannot be obtained only by Ross theory, because the raw materials have identical interfacial tension and surface tension.

Also, the authors of Ind. Eng. Chem. Fundam., 16 (4), 472 (1977) propose the pinhole effect that foam-breaking occurs when a hydrophobic powdery particle adsorbs a surfactant which stabilizes a foam film, and thus foam is destabilized to be broken. The pinhole effect is a theory pointed out in many silica-containing silicone defoamers. Also, it is empirically believed that many silica-containing defoamers cause so-called needle effect in which a tip end of silica physically breaks foam.

However, it is not discussed what requirement is necessary for hydrophobic powdery particles such as silica to arrive at or exist near a foam film. That is, unless the condition for the effective exhibition of the pinhole effect or needle effect is clarified, a practical relationship with defoaming performance cannot be found.

Also, the author of Int. J. Mineral Process., 9, 1 (1982) discloses the mechanism that a defoamer breaks both surfaces of a foam film to have a bridge structure, and thereafter the both surfaces are short-circuited by bouncing of water, which leads to foam-breaking. Furthermore, Langmuir, 15 (24), 8514 (1999), discloses the mechanism that the bridge structure is stretched in a direction inside the foam film, and the defoamer portion is thinned so that foam is destabilized, which leads to foam-breaking. In these models, the formation of the bridge structure by a defoamer is understood as a first step toward foam-breaking.

However, since a design factor for speeding up the formation of the bridge structure for various types of foams is not clarified, these models do not contribute to designing a defoamer.

Also, the Journal of Oleo Science, 42 (10), 762 (1993), discloses that an electric double layer created with adsorption molecules such as a surfactant on the surface of a foam film serves to maintain the thickness of the foam film at a certain value or more, and the adsorption molecules are substituted with a defoamer, so that the stabilization mechanism by the repulsion of the electric double layer collapses, which increases the likeliness of foam-breaking.

However, while the foam-breaking with a defoamer usually occurs at a foam film thickness of 1 μm or more, it is known that the repulsion by the electric double layer between two foam film inner walls is not expressed until the foam film becomes as thin as about 20 nm. This suggests that the repulsion by the electric double layer does not need to be considered when a defoamer is designed.

Consequently, according to a most common silicone defoamer composition that is of the type to be previously added to a foaming liquid and contains a composite particle of silicone and silica as disclosed in JP 2008-529778, a concrete and quantitative index regarding the chemical composition and production of a silicone defoamer composition in order to obtain certain defoaming performance for each production formulation and production batch cannot be obtained only by the above-described defoaming theory.

Accordingly, the defoamer of this type could be developed only by acquiring a target foaming liquid and finding an optimal condition of the chemical composition and production method based on experiences through trial and error. Also, in the production, reproducibility of defoaming performance among batches was not sufficient. The control method has been qualitative visual observation, and a control method based on a quantitative index has not been found.

In JP 6344878, the applicant mentions a variation of the state among composite particles, in an aqueous dispersion including high-level aggregates formed through a non-chemical bond with low-level aggregates of an inorganic particle group, like fumed silica particles, and in an oil-in-water Pickering emulsion obtained by adding an oil into such an aqueous dispersion. The applicant of JP 6344878 also indicates that a zeta potential measured for evaluating stability and homogeneity of an aqueous dispersion can serve as an index of stability and homogeneity. However, this merely indicates that a narrower distribution width of a zeta potential achieves favorable stability and homogeneity, and does not demonstrate influence on defoaming performance. Also, a stable emulsion did not necessarily have a narrow distribution width of a zeta potential.

The zeta potential is also sometimes used for the purpose of improving the fiber treatment and the stability of a coat film. However, this was intended to promote the adsorption of a substance.

As described above, neither an index for evaluating the defoaming performance of a defoamer by a zeta potential nor a prior art suggesting such an index has existed.

Thus, the conventional silicone defoamer of the type to be previously added for defoaming did not have an index for measuring general defoaming performance independently from the type of the used silicone component and silica or the type of the foaming liquid. Therefore, there has been no method for expressing defoaming performance which is constant for every production formulation and product batch and has favorable reproducibility. Accordingly, repeated trial and error regarding the chemical composition and process could not be eliminated.

Furthermore, no index has existed for controlling initial defoaming performance and defoaming persistence, controlling defoaming performance and dispersion stability, and controlling foam-suppressing and foam-breaking.

### BRIEF SUMMARY

In some embodiments, a silicone defoamer composition is provided of the type to be previously added to a given foaming liquid, which can ensure dispersibility of a defoamer in a foaming liquid as well as defoaming persistence by exerting a defoaming property through both foam-suppressing and foam-breaking.

In other embodiments, a method for producing a silicone defoamer composition of the type to be previously added to a given foaming liquid is provided, which can ensure dispersibility of a defoamer in a foaming liquid as well as defoaming persistence by exerting a defoaming property through both foam-suppressing and foam-breaking, whereby a silicone defoamer composition is stably and reproducibly produced depending on a foaming liquid.

### DETAILED DESCRIPTION

None of the conventional technologies discloses silicone defoamer compositions and methods of producing the same that solve the above-described problems.

In some embodiments, a silicone defoamer composition in which the distribution width of the zeta potential of the composite particles of the silicone defoamer composition is equal to or greater than a threshold value set depending on a foaming liquid has excellent defoaming performance with respect to various types of foams is provided.

For describing the present invention, a mixture of an oil having a silicone oil as an essential component and silica as well as a product in which some of the components are bonded by a chemical reaction may be referred to as a compound.

The silicone defoamer composition of the present invention is a silicone defoamer composition of a type which defoams by being previously added to a foaming liquid. The silicone defoamer composition is characterized by including a composite particle group of an oil containing silicone as an essential component and silica, and in that the distribution width of the zeta potential of the composite particle group is set depending on the foaming liquid such that any of the composite particles in the composite particle group reaches the inner surface of a surrounding film constituting the foam formed by the foaming liquid so as to enable foam-suppressing and foam-breaking.

The method for producing a silicone defoamer composition according to the present invention is a method for producing a silicone defoamer composition of the type which defoams by being previously added to a foaming liquid. The method is characterized by including: a stage of selecting the type and/or amount for each of an oil component and a silica component depending on the type of a foaming liquid; a stage of mixing the selected oil component and silica component to prepare a silicone defoamer composition including a composite particle group of an oil containing silicone as an essential component and silica; a stage of obtaining a sample of the silicone defoamer composition generated and measuring a distribution width of a zeta potential of the composite particle group; and repeating the selecting stage and/or the adjusting stage, and the measuring stage until the measured distribution width of a zeta potential becomes a threshold value or more which is set depending on the foaming liquid such that the defoamer reaches an inner surface of a surrounding film constituting foam formed with the foaming liquid so as to enable foam-suppressing and foam-breaking.

According to the silicone defoamer composition of the present invention, regarding the defoaming persistence in the defoamer that is of the type to be previously added into a given foaming liquid, the distribution width of a zeta potential of the composite particle group is preferably narrow in terms of the dispersibility of the composite particle group of the defoamer. On the other hand, the condition of the foam to be subjected to defoaming changes depending on the type of the foaming liquid and the transient state from the start to completion of the formation of foam. When the dispersibility of the composite particle group in the foaming liquid is ensured at the start of the formation of foam, some composite particle of the composite particle group is likely to exist inside foam. Furthermore, the distribution width of a zeta potential of the composite particle group is set depending on the foaming liquid such that the composite particle reaches the inner surface of the surrounding film of foam to enable defoaming through both the foam-suppressing due to a decrease of an interfacial tension of a foam film and the foam-breaking due to the pinhole effect or the needle effect.

It is noted that the foam-suppressing means a defoaming action that is dominantly an action in which foam is not formed or is unlikely to be formed mainly due to the fact that the interfacial tension of an inner surface of foam is reduced by the composite particle in a foaming liquid. That is, it indicates an action in which no foam is generated at all, or an action in which foam has been already generated, but foam is unlikely to be newly generated. Also, the foam-breaking indicates a defoaming action that is dominantly an action in which already generated foam is broken mainly due to the pinhole effect or needle effect by the composite particle.

Also, the defoaming property and defoaming performance has a broad meaning which encompasses both the foam-suppressing and the foam-breaking. A favorable defoaming property indicates, unless otherwise stated, that each of an initial defoaming property and defoaming persistence is at not lower than a level that is acceptable at least in defoaming sites.

The method for producing a silicone defoamer composition according to the present invention is a method for producing a defoamer of the type to be previously added to a given foaming liquid, including: a stage of selecting the type and/or amount for each of an oil component and a silica component depending on the type of a foaming liquid; a stage of mixing the selected oil component and silica component to prepare a silicone defoamer composition which includes a composite particle group of an oil containing silicone as an essential component and silica; and a stage of obtaining a sample of the generated silicone defoamer composition and measuring a distribution width of a zeta potential of the composite particle group, in which the measured distribution width of a zeta potential is a threshold value or more that is set depending on a foaming liquid for ensuring dispersibility of the defoamer in the foaming liquid such that the defoamer reaches an inner surface of a surrounding film constituting foam formed with the foaming liquid for enabling foam-suppressing and foam-breaking, and a defoaming performance can be stably exerted with favorable reproducibility depending on a foaming liquid.

Furthermore, the trial and error for producing a defoamer having required performance depending on a foaming liquid is reduced by repeating the selecting stage and/or the adjusting stage, and the measuring stage until the measured distribution width of a zeta potential becomes a threshold value or more which is set depending on a foaming liquid.

Details of the silicone defoamer composition of the present invention and the method for producing the same will be described below.

The present invention is directed to both the case of defoaming by addition to a foaming liquid in the form of a compound and the case of defoaming by addition to a foaming liquid after emulsification of the compound. Embodiments for implementing the invention for both cases will be described below.

The silicone defoamer composition of the present invention is a compound composed of an oil containing silicone as an essential component and silica, or an emulsion obtained by emulsifying the compound. The silicone defoamer composition in the form of a compound is added directly to a foaming liquid, or is prepared as an aqueous dispersion liquid as appropriate and then added thereto. The silicone defoamer composition in the form of an emulsion is added to a foaming liquid as it is or after dilution with water as appropriate.

The silicone is an organopolysiloxane having an average composition formula represented by the general formula (1). The chemical structure may be linear or branched, but needs to be oily.

R1aSiO(4−a)/2 (1)

In the formula (1), R1 may be the same or different in a molecule and is a substituted or unsubstituted saturated or unsaturated monovalent hydrocarbon group having 1 to 25 carbon atoms, a substituted or unsubstituted aromatic group having 6 to 30 carbon atoms, a hydroxyl group, an alkoxy group having 1 to 6 carbon atoms, or a hydrogen atom group.

Specific examples of the above-described organic groups may include an alkyl group such as a methyl group, an ethyl group, a propyl group, an isopropyl group, a butyl group, a tert-butyl group, a pentyl group, a neopentyl group, a hexyl group, a 2-ethylhexyl group, a heptyl group, an octyl group, a nonyl group, a decyl group, and a dodecyl group; a cycloalkyl group such as a cyclopentyl group, a cyclohexyl group, and a cycloheptyl group; an aryl group such as a phenyl group, a tolyl group, a xylyl group, a biphenyl group, and a naphthyl group; an aralkyl group such as a benzyl group, a phenylethyl group, a phenylpropyl group, and a methylbenzyl group; a nitrogen-containing hydrocarbon group represented by —CH2—CH2—CH2—N2, —CH2—CH2—CH2—NH(CH3), —CH2—CH2—CH2—N(CH3)2, —CH2—CH2—NH—CH2—CH2—NH2, —CH2—CH2—CH2—NH(CH3), —CH2—CH2—CH2—NH—CH2—CH2—NH2, —CH2—CH2—CH2—NH—CH2—CH2—N(CH3)2, —CH2—CH2—CH2—NH—CH2—CH2—NH(CH2CH3), —CH2—CH2—CH2—NH—CH2—CH2—N(CH2CH3)2, and —CH2—CH2—CH2—NH—CH2—CH2—NH(cyclo-C6H11); and a substituted hydrocarbon group in which part or all of hydrogen atoms in a hydrocarbon group are substituted by a halogen atom, cyano group or the like such as a chloromethyl group, a 2-bromoethyl group, a 3,3,3-trifluoropropyl group, a 3-chloropropyl group, a chlorophenyl group, a dibromophenyl group, a tetrachlorophenyl group, a difluorophenyl group, a β-cyanoethyl group, a γ-cyanopropyl group, and a β-cyanopropyl group. Particularly preferred organic groups are a methyl group, a —CH2—CH2—CH2—NH—CH2—CH2—NH2 group, and a phenyl group.

a is a numerical value related to the order of the siloxane bond, and a being 2.0 indicates a straight chain organopolysiloxane. a is a positive number satisfying 1.9≤a≤2.2, and preferably 1.95≤a≤2.15. When a is less than 1.9, the viscosity of the organopolysiloxane becomes too low. Thus, separation of the silicone component and the silica component is likely to occur in the foaming liquid, so that the defoaming persistence deteriorates. When a exceeds 2.2, the interfacial tension lowering action of the foam film is not sufficient, so that the initial defoaming property deteriorates and is unsuitable.

The organopolysiloxane may contain a single component or a mixture of two or more components.

The viscosity of the organopolysiloxane at 25° C. is preferably 1 to 2,000,000 mPa·s. The viscosity is more preferably in the range of 1 to 100,000 mPa·s, and particularly preferably 1 to 50,000 mPa·s. When the viscosity is below 1 mPa·s, or exceeds 2,000,000 mPa·s, the silicone defoamer composition in the form of a compound cannot be stably dispersed in the foaming liquid. In the case of an emulsion, emulsification is difficult and a stable emulsion cannot be obtained.

The organopolysiloxane may have any structure as long as the above-described conditions are satisfied. From the viewpoints of easy availability, economic efficiency, and chemical stability, 80 mol % or more, particularly 90 mol % or more of the total R1 in the structure of the organopolysiloxane is preferably a methyl group.

As the oil used in the silicone defoamer composition of the present invention, silicone is an essential component, but a mixture of an organic oil in addition to silicone may be used. Any type of oil may be used as long as the oil exhibits fluidity and is compatible with silicone. Various mineral oils, synthetic oils, vegetable oils, and the like are exemplified. The optimum type of oil is selected depending on the field of use of foaming liquids. For example, in the field of foods, vegetable oils that have little influence on the human body are used. Either one or two or more types of organic oils may be used in combination.

The use ratio of the silicone and the organic oil is not limited, and it is preferable that the ratio of the silicone is 50% by mass or more. If it is less than 50% by mass, the effect of lowering the interfacial tension by silicone cannot be sufficiently obtained.

In the silicone defoamer composition of the present invention, silica is an essential component. Since silica is required to be dispersed in the foaming liquid as a composite particle together with the oil containing silicone as an essential component, the silica needs to be in a particulate form.

The silica particles are particles of silicon dioxide produced by a synthetic method, and do not include mineral-based silica such as diatomaceous earth or crystalline quartz. Examples of silicon dioxide produced by a synthetic method may include fine powders produced by a dry method such as fumed silica, pyrogenic silica, fused silica, and the like, and precipitated silica or colloidal silica produced by a wet method. These are known to those skilled in the art. Among these, pyrogenic silica, precipitated silica, or colloidal silica is preferably used. These can be used alone or in combination of two or more types. The silica particles used in the present invention may be hydrophilic silica in which silanol groups on the surface remain, or hydrophobic silica in which silanol groups on the surface are silylated. Hydrophobic silica can be produced by known methods of treating hydrophilic silica with hydrogenated organosilicon such as methyltrichlorosilane, alkoxysilanes such as dimethyldialkoxysilane, silazane, or low molecular weight methylpolysiloxane.

The silica particles need to be particulate rather than agglomerate. In addition, the silica particles may be in a state of a primary aggregate in which primary particles are aggregated, or a state of a secondary aggregate in which primary aggregates are further aggregated.

In the present invention, when the compound composed of the oil containing silicone as an essential component and silica or the emulsion obtained by emulsifying the compound is used as the defoamer of the type to be previously added to a foaming liquid, attention is given to the zeta potential of the composite particle composed of the oil and the silica of the silicone defoamer composition of the present invention as an index showing good defoaming performance.

The zeta potential refers to a potential on a liquid surface (slip surface) which moves together with a dispersion in a liquid, and generally used as an index of an electric charge state of a dispersion. For example, when two dispersion particles each have a zeta electron with the same sign and a sufficiently large absolute value, collision is prevented due to electrostatic repulsion, and thus they do not aggregate. In recent years, there is an attempt to expand the concept of a zeta potential to a plate and a fiber. For example, when a metal plate as an untreated agent and a dispersion have a zeta potential with the same or different sign and a small absolute value, the dispersion is likely to adsorb to the untreated agent.

The zeta potential has been used as an index which can indicate dispersion stability of silica in an aqueous dispersion of silica to some extent. It has been said that the narrower the distribution width of a zeta potential of an aqueous dispersion liquid, the more favorable the dispersion stability. It is considered that a narrow distribution width of a zeta potential means existence of many silica particles each exhibiting the same sign and a similar potential, and silica particles are less likely to aggregate, resulting in favorable dispersion stability.

In this manner, the zeta potential has been used as an index of the stability and aggregating property of particles in an aqueous dispersion of particles. In the present invention, it was remarkably found that the zeta potential can also be used as an index of the defoaming performance by the composite particle.

The mechanism in which defoaming occurs when the composite particle group of the silicone defoamer composition according to the present invention exists at the interface of a foam film can be explained by Ross theory and the like. That is, defoaming is enabled by the lowered interfacial tension of a foam film caused by silicone and the pinhole effect or needle effect caused by a silica particle. However, a requirement for achieving the state that the composite particle of the silicone defoamer is close to the interface of a foam film has not been clarified.

When the composite particle group of the silicone defoamer composition according to the present invention is dispersed in water or in a foaming liquid, various potentials determined by differences of the chemical composition and/or morphology are generated on the surface of the composite particle. A variation of the potential, including a difference of the sign, occurs within one composite particle and among the composite particles. Also, such a condition changes with time. Between different composite particles, points having potentials with different signs attract each other. Points with the same signs repel each other in some cases, but they can also be close to each other to such a degree that they do not repel each other in other cases. Particles always move by convection and Brownian motion. Furthermore, an inside of a particle is high in viscosity, but is still in the category of fluid. Therefore, the chemical structure also always moves. Accordingly, a distribution of a potential is always in flux inside the composite particle and among the composite particles. Thus, both an attracting portion and a separating portion exist between the composite particles, and are always changing.

Consequently, when the composite particle group of the silicone defoamer composition according to the present invention is dispersed in water or in a foaming liquid, stability is ensured as the composite particle group, while some composite particle has a channel in which it can potentially approach another composite particle or another substance.

On the other hand, potentials at an inner interface of individual bubbles in a foaming liquid are non-uniform at every location. Also, in the transient situation from the start to completion of the formation of foam, the distribution of a potential at every location also changes from moment to moment with time. For effectively exerting the defoaming action of the composite particle of the silicone defoamer composition according to the present invention under such circumstances, dispersibility of the composite particle group in the foaming liquid needs to be ensured at the start of the formation of foam such that some composite particle of the composite particle group is likely to exist inside foam, and the composite particle of the silicone defoamer composition reaches an inner surface of a surrounding film constituting foam formed with the foaming liquid.

There may be a point where the composite particle group of the silicone defoamer composition according to the present invention and the surrounding film constituting foam formed with the foaming liquid can approach each other by a potential action. If a relationship between a potential in a channel of some composite particle of the composite particle group and a potential at some point on an inner surface of a surrounding film constituting foam is optimized, the composite particle can reach the inner surface of the surrounding film to enable defoaming through the lowered interfacial tension of a foam film caused by silicone and/or the pinhole effect or needle effect caused by silica particles. Therefore, when the composite particle of the silicone defoamer composition has various potential channels for causing such optimization, the probability of exhibiting the defoaming action increases.

The above-described relationship will be described from the viewpoint of a zeta potential. That is, the condition of a zeta potential on an inner surface of a surrounding film of foam changes depending on the type of the foaming liquid and the transient state from the start to completion of the formation of foam.

In the present invention, it was found that the defoaming effect is effectively enhanced under such circumstances by widening the distribution width of a zeta potential of the composite particle of the silicone defoamer composition. This is because an optimal point for exerting the defoaming effect appears somewhere in a variation in the state of the inner surface of the surrounding film of foam and a variation in the state of the surface of the composite particle.

Since the sign and distribution state of a potential on an inner surface of foam vary depending on the type of a foaming liquid to be subjected to defoaming and the state of foam, the defoaming effect should be maximized with a composite particle having the most suitable and frequent zeta potential and zeta potential distribution. However, in the present invention, it was found that the defoaming effect can be enhanced when, instead of owing to the above-described circumstances, the distribution width of a zeta potential of the composite particle is wide. However, for exerting a given defoaming effect for a given foaming liquid, a threshold value of the lower limit of a zeta potential in the composite particle is preferably set individually and specifically.

There is a possibility that not only the distribution width of the zeta potential of the composite particle of the silicone defoamer composition but also the shape and peak height of the distribution may have an influence on the defoaming performance, but it is not known at present. At present, it is estimated that, when both ends of the peak tail in the entire area of the zeta potential distribution peak are assumed to be 0% and 100%, respectively, it is effective to define the widths of the 10% point and the 90% point as the distribution width. The distribution width of the zeta potential is considered to be sufficient for a channel for defoaming of a certain existence probability or more to exist.

Further, when the peak of the distribution of the zeta potential is divided into two or more, it is estimated that it is not suitable as a target as the distribution width of the zeta potential to be handled in the present invention. It is estimated that the influence of the distribution width of the zeta potential on the defoaming performance is more relevant when the peak is one. Note that, when the peak has a shoulder, the peak is defined as one peak.

The higher the distribution width of the zeta potential of the composite particles of the silicone defoamer composition, the lower the dispersion stability in the foaming liquid. In the present invention, the dispersion stability of the composite particles in the foaming liquid can be ensured by setting a fixed upper limit value for the distribution width of the zeta potential.

In the conventional defoamer of composite particles made of silicone and silica, which are previously put in a foaming liquid, dispersion stability is not necessarily sufficient, and dispersion stability often varies from one manufacturing formulation or batch to another. On the other hand, since the composite particle group of the silicone defoamer composition of the present invention ensures dispersion stability, the foam-suppressing property can be sufficiently and stably exhibited in addition to the foam-breaking property. As described above, since both the functions of the foam-suppressing property and the foam-breaking property can be exhibited, both the initial defoaming property and the defoaming persistence can be exhibited.

However, since the dispersion stability of the defoamer is regarded as more important as compared with the defoamer of the type in which the defoamer is introduced from the outside of the foaming liquid, the defoaming persistence is characterized more than the initial defoaming property is.

In order to grasp the zeta potential of the composite particles of the silicone defoamer composition of the present invention, in the case of the compound form, the zeta potential is measured by dispersing it in water using a surfactant or the like as appropriate, and in the case of the emulsion form, the zeta potential is measured by diluting it with water or the like as appropriate. In each of the methods, the zeta potential is measured by simulating a state in which the composite particles are dispersed in the foaming liquid.

The distribution width of the zeta potential of the composite particles of the silicone defoamer composition is determined by the compositional and morphological heterogeneity within a particle and/or between particles of the composite particles. As each of the compositional heterogeneity and the morphological heterogeneity increases, the distribution width of the zeta potential of the composite particle increases. The larger both the compositional and morphological heterogeneity, the wider the distribution width of the zeta potential.

In order to widen the distribution width of the zeta potential of the composite particles, a specific method for increasing the compositional heterogeneity and the morphological heterogeneity will be described below.

In the silicone defoamer composition, employing composite particles using not only the oil but also silica, that is, employing silica particles, broadens the distribution width of zeta potential. In addition, a variety of types and forms of oils containing silicone as a main component and silica expand the distribution width of zeta potentials. Specific methods for increasing the compositional heterogeneity may include the following.

The greater the number of types of silica particles used, the greater the compositional heterogeneity and the wider the distribution width of the zeta potential. The greater the number of types of silicone component used, the greater the compositional heterogeneity and the wider the distribution width of the zeta potential. When an organic oil is used in combination with a silicone component as an oil, the compositional heterogeneity becomes large and the distribution width of the zeta potential becomes wide. Further, the greater the number of types of organic oils, the greater the compositional heterogeneity, and the wider the distribution width of the zeta potential.

Specific methods for increasing morphological heterogeneity may include the following. The greater the mass ratio of the silica particles to the oil, the greater the morphological heterogeneity within one composite particle and between the composite particles, and the wider the distribution width of the zeta potential. The greater the number of types of silica particles used, the greater the morphological heterogeneity within one composite particle and between the composite particles, and the wider the distribution width of the zeta potential.

When the silicone defoamer composition is in the emulsion form, the lower the shear speed during emulsion manufacture, the greater the morphological heterogeneity within one composite particle and between the composite particles, and the wider the distribution width of the zeta potential.

In the case where the composite particles of the silicone defoamer composition are dispersed in advance in the foaming liquid, in order to obtain the target initial defoaming property, the distribution width of the zeta potential is set depending on the foaming liquid. More specifically, the distribution width of the zeta potential is made to be a threshold value or more that is set depending on the type of the foaming liquid, the type and concentration of the dissolved substance such as ionic substance, the liquid property, the properties of the foam, and the like. The composition is designed so that the distribution width of the zeta potential becomes a predetermined threshold value or more, and the manufacturing conditions and the like are optimized to bring the morphological heterogeneity of the composite particles into a desired state.

When the silicone defoamer composition is in the emulsion form, a stage of checking the distribution width of the zeta potential is provided in the producing process. When the distribution width of the zeta potential is less than a predetermined threshold value, reworking is performed, so that the shear speed and other process factors are optimized, and the checking and reworking are repeated until the distribution width of the zeta potential becomes a predetermined threshold value or more, whereby the target initial defoaming property can be reliably obtained.

Until now, in this industry, the wider distribution width of the zeta potential is preferred, and there has been no idea of controlling the distribution width.

Although the effectiveness of control of the distribution width of the zeta potential is not limited to a defoamer, the control of the distribution width is most preferable for the defoamer because the electric potential of the foam film is not uniform and the control is particularly effective for transient situations.

On the other hand, as to the deforming persistence, it is necessary to maintain the stability and dispersibility of the composite particles of the silicone defoamer and also to cope with a change in the electric potential of the inner surface of the foam film with a change in time. For this purpose, it is necessary that the composite particles have various surface potentials, i.e., have a wide distribution width of zeta potentials. That is, since the distribution width of the zeta potential is wide, the composite particles once deviated from the defoaming performance are reused, whereby the defoaming persistence is obtained. Therefore, the wide distribution width of the zeta potential of the silicone defoamer improves both the initial defoaming performance and the defoaming persistence performance.

The wide distribution width of the zeta potential of the dispersed particles in the silicone defoamer composition increases the initial defoaming property and defoaming persistence. However, the dispersion stability of the composite particles in the foaming liquid and the dispersion stability of the composite particles in an emulsion in the case of the silicone defoamer composition being in the emulsion form decrease as the distribution width of the zeta potential of the composite particles increases. This is because the wider the distribution width of the zeta potential, the greater the opportunities of attraction, i.e., aggregation, between the composite particles.

Since the electric potential of the foam film in the foaming liquid changes from time to time, it is important to use various channels of composite particles of the silicone defoamer composition. For this purpose, stable dispersion of the composite particles in the foaming liquid is necessary. Therefore, in order to achieve both the initial defoaming property and the defoaming persistence, it is necessary to set a predetermined upper limit value of the distribution width of the zeta potential according to the purpose.

When the silicone defoamer composition is in the emulsion form, it is necessary to set a predetermined upper limit value of the distribution width of the zeta potential for the above-mentioned reason when stability as an emulsion is ensured. Similarly, also in the case where the dispersion stability of the composite particles in the foaming liquid is regarded as important, it is preferable to set a predetermined upper limit value of the distribution width of the zeta potential.

Among the compositional heterogeneity and the morphological heterogeneity for widening the distribution width of the zeta potential of the composite particles of the silicone defoamer described above, for the silica particles which mainly contribute to the morphological heterogeneity, the larger the mass ratio of the silica to the oil in the silicone defoamer composition, the higher the initial defoaming property. However, in the case of achieving both the initial defoaming property and the defoaming persistence, or in the case of ensuring the dispersion stability of the particles of the emulsion, it is necessary to provide a predetermined upper limit value for the mass ratio of silica to the oil in view of the balance with the zeta potential of the composite particles.

In the present invention, the condition of the foam to be subjected to defoaming changes depending on the transient state from the start to completion of the formation of foam in a foaming liquid. When the dispersibility of the composite particle group in the foaming liquid is ensured at the start of the formation of foam, some composite particle of the composite particle group is likely to exist inside foam. Furthermore, the distribution width of a zeta potential of the composite particle group is set depending on the foaming liquid such that the composite particle reaches the inner surface of the surrounding film of foam to enable defoaming through both the foam-suppressing due to a decrease of an interfacial tension of a foam film and the foam-breaking due to the pinhole effect or the needle effect.

In transient situations, determining the distribution width of the zeta potential may differ depending on temporal and spatial conditions as to whether compositional or morphological heterogeneity dominates. It can also be presumed that the prevalence of either compositional or morphological heterogeneity affects whether the defoaming is achieved by mainly the foam-suppressing or the foam-breaking. For this reason, the action of the silicone defoamer composition between the foam-suppressing and the foam-breaking can be controlled to some extent by selectively using two factors, for example, the ratio of the amount of silica in the silicone defoamer composition and the shear speed at the time of producing the emulsion.

It is believed that any form of silicone defoamer other than a compound or emulsion will improve defoaming performance due to similar behavior in the foaming liquid. Therefore, the relationship between the zeta potentials of the particles should theoretically hold. However, these defoamers have difficulty in producing a water dispersion state for measuring the zeta potential. Thus, in the present invention, the silicone defoamer composition was intended to be limited to the compound or emulsion form.

The procedure for the development of silicone defoamer compositions in view of the present invention will now be described.

1. Confirm the restrictions on the viscosity of the silicone oil and the type of organic oil that can be used, depending on the use application and the type of foaming liquid.

2. Examine chemical compositions in which the numbers of respective types of silicone oil, silica, and organic oil are increased as much as possible, and the amount of silica is also increased as much as possible. (Making the zeta potential of the composite particles as wide as possible)

3. When the defoamer composition is in the emulsion form, examine a producing method in which the shear speed during the production of an emulsion is reduced as much as possible. (Making the zeta potential of the composite particles as wide as possible)

4. Optimize the conditions 2 and 3 to balance the required initial defoaming property, defoaming persistence and dispersion stability according to the use application and purpose.

The procedure for producing the silicone defoamer composition developed by the above-described development procedure will now be described.

The procedure includes: a stage of selecting the type and/or amount for each of an oil component and a silica component depending on the type of a foaming liquid; a stage of mixing the selected oil component and silica component to prepare a silicone defoamer composition including a composite particle of an oil and silica; a stage of obtaining a sample of the generated silicone defoamer composition and measuring a distribution width of a zeta potential of the composite particle; and repeating the selecting stage and/or the adjusting stage, and the measuring stage until the measured distribution width of a zeta potential becomes a threshold value or more which is set depending on the foaming liquid such that the defoamer suppresses the foam formation in the transient state from the start to completion of the foam formation from the foaming liquid.

When the silicone defoamer composition is in the compound form, the zeta potential is measured while the silicone defoamer composition is in a state of a water dispersion. When the composition is in the emulsion form, the silicone defoamer composition is prepared by shearing at a predetermined shear speed during the production of the emulsion and the zeta potential thereof in the form of emulsion is measured.

For example, a kneader such as a gate mixer, a kneader, a pressure kneader, a biaxial kneading base, or an intensive mixer can be used to knead the oil and silica into a compound. Appropriate conditions are selected by taking time and temperature such that sufficient compositional heterogeneity and morphological heterogeneity appear within one particle and between particles when the composite particles are formed. Optionally, a method in which a chemical bond is formed between the oil and the silica may be selected.

The mass ratio of silica to oil is a factor that influences the distribution width of the zeta potential of the composite particles. The preferable range of the mass ratio depends on the type of the foaming liquid and the target defoaming performance, but it is preferable that the amount (parts by mass) of silica to 100 parts by mass of the oil is 0.5 parts by mass or more and 40 parts by mass or less. If it is less than 0.5 part by mass, the distribution width of the zeta potential is not sufficiently wide, and sufficient defoaming performance cannot be obtained. When the amount exceeds 40 parts by mass, it is difficult to achieve both the initial defoaming property and the defoaming persistence, and when the defoamer is in the emulsion form, there arises a problem that the stability as an emulsion is lowered, for example, particles are precipitated. More preferably, the amount is in the range of 1 part by mass or more and 30 parts by mass or less.

When the silicone defoamer composition is in the emulsion form, the preferred content of the oil in 100 parts by mass of the emulsion is in the range of 1 part by mass or more and 90 parts by mass or less. If it is less than 1 part by mass, sufficient emulsification accuracy cannot be obtained and the yield also decreases. If it exceeds 90 parts by mass, the viscosity of the aqueous emulsion becomes high, so that the handling property becomes poor. More preferably, the content is in the range of 2 parts by mass or more and 70 parts by mass or less.

Known methods can be used to form the above-described compound into an emulsion. The emulsion may be a self-emulsifying emulsion using polyoxyethylene alkylene-modified organopolysiloxane as an emulsifier, or may be a common emulsion using a nonionic surfactant as an emulsifier. When anionic surfactants or cationic surfactants are used, the charge on the surface of the defoamer composition wrapped by these ionic surfactants becomes uniform, so that a zeta potential having a wide distribution width as in the present invention cannot be obtained, and strong defoaming performance is exhibited only for some foams. Therefore, it is highly preferable to use a nonionic surfactant in order to realize the present invention.

When polyoxyethylene alkylene-modified organopolysiloxane is used to produce the self-emulsifying defoamer composition, the amount of polyoxyethylene alkylene-modified organopolysiloxane used is preferably 1 part by mass or more and 30 parts by mass or less in 100 parts by mass of the emulsion. If it is less than 1 part by mass, emulsification cannot be performed sufficiently, and if it exceeds 30 parts by mass, the polyoxyethylene alkylene-modified organopolysiloxane in such an amount does not contribute for widening the distribution width of the zeta potential. More preferably, the amount is 2 parts by mass or more and 20 parts by mass or less.

When a common emulsion is formed using a nonionic surfactant, the amount of the nonionic surfactant used is preferably 1 part by mass or more and 30 parts by mass or less in 100 parts by mass of the emulsion. If it is less than 1 part by mass, emulsification cannot be performed sufficiently, and if it exceeds 30 parts by mass, the nonionic surfactant in such an amount does not contribute for widening the distribution width of the zeta potential. More preferably, the amount is 2 parts by mass or more and 20 parts by mass or less.

The polyoxyethylene alkylene-modified organopolysiloxane or the nonionic surfactant may be used alone or in combination of two or more types, and the total content is preferably 1 part by mass or more and 50 parts by mass or less in 100 parts by mass of the emulsion. If it is less than 1 part by mass, emulsification cannot be performed sufficiently, and if it exceeds 50 parts by mass, these compounds in such an amount do not contribute for widening the distribution width of the zeta potential. More preferably, the amount is 2 parts by mass or more and 30 parts by mass or less.

The method for producing the silicone defoamer composition in the emulsion form of the present invention is not particularly limited as long as it is within the above-mentioned method, and the silicone defoamer composition in the emulsion form can be produced by a known method. For example, the silicone defoamer composition in the emulsion form can be produced by mixing and emulsifying the above-described components using a common mixer suitable for producing emulsions, such as a homogenizer, colloid mill, homomixer, high speed stator rotor stirrer, or the like.

The shear speed applied to the compound particles at the time of producing the emulsion is preferably 5,000 s−1 or more and 100,000 s−1 or less. If the shear speed is less than 5,000 s−1, the dispersion stability of the emulsion particles deteriorates, and the particles are likely to settle or the defoaming persistence is likely to be insufficient. In addition, if the shear speed exceeds 100,000 s−1, variations in terms of compositional feature and/or morphological feature within and/or between the composite particles become excessively small, so that the distribution width of the zeta potential becomes narrow, and satisfactory defoaming performance cannot be obtained. More preferably, the shear speed is 7,000 s−1 or more and 50,000 s−1 or less.

The silicone defoamer composition in the emulsion form of the present invention may contain polyoxyalkylene alkyl ethers such as polyoxyethylene tridecyl ether, polyoxyethylene hexadecyl ether, and polyoxyethylene octadecyl ether, nonionic surfactants such as polyoxyethylene hardened castor oil and polyoxyethylene sorbitan acid ester, and ionic surfactants such as sodium lauroyl glutamate and sodium dilauramidoglutamide lysine, in an amount that does not impair the object of the present invention.

The amount of the surfactant is preferably 50 parts by mass or less, more preferably 30 parts by mass or less, in 100 parts by mass of the emulsion. If the amount of the surfactant exceeds 50 parts by mass, the surfactant adversely affects the environment, and the aggregation force of the silica particles decreases, thereby impairing the storage stability of the product and handling property at the time of dilution.

The silicone defoamer composition in the emulsion form of the present invention may contain salicylic acid, sodium benzoate, sodium dehydroacetate, potassium sorbate, phenoxyethanol, methyl parahydroxybenzoate, and butyl parahydroxybenzoate as a preservative, in an amount that does not impair the object of the present invention. Further, other additives may be added to the composition of the present invention as long as they do not contradict the spirit of the present invention. For example, a pH adjusting agent, a colorant, an antioxidant, a deodorant, a cross-linking agent, various catalysts, an emulsion stabilizer, various organic solvents, a chelating agent, and the like may be added.

The type of water used in the silicone defoamer composition in the emulsion form of the present invention is not particularly limited, and ion-exchanged water is preferably used. Ion-exchanged water having a pH value in the range of 2 to 12, more preferably in the range of 4 to 10, is preferably used.

The particle size of the emulsion particles in the silicone defoamer composition in the emulsion form of the present invention is preferably in the range of 0.1 μm or more and 1000 μm or less. If it is 0.1 μm or less, sufficient defoaming performance cannot be exhibited, and if it exceeds 1000 μm, a problem such as particle precipitation property occurs. A range of 0.5 μm or more and 500 μm or less μm is more preferable. In the present invention, the average particle size can be measured by a particle size-distribution measuring device N4Plus manufactured by Beckman Coulter, Inc., for example.

As described above, in the silicone defoamer composition in the emulsion form of the present invention, the particle size can be stably controlled by the oil containing silicone as an essential component and the silica particle and by the producing method thereof, whereby the dispersion of the particle size can be narrowed. Thus, the storage stability and the stability at the time of application development are enhanced.

The zeta potential of the composite particles of the silicone defoamer composition according to the present invention exhibits similar tendency for defoaming performance and stability, as measured by any method or apparatus. However, as for the concentration of the composite particles in the aqueous dispersion liquid in the measurement of the zeta potential, there is a range in which an appropriate value can be obtained. The concentration of the composite particles in the aqueous dispersion liquid is preferably 10 ppm or more and 50,000 ppm (5%) or less. If the concentration is less than 10 ppm or exceeds 50,000 ppm (5%), appropriate values may not be derived. Therefore, if the silicone defoamer composition is in the emulsion form, it is diluted with water or concentrated to achieve the preferred composite particle concentration. In the case of the compound form, it is dispersed in water at the preferred concentration. As necessary, it is dispersed using a surfactant or the like as appropriate.

The pH of the aqueous dispersion liquid for measuring the zeta potential also influences the measurement result on the zeta potential. When the pH of the bubble liquid is known in advance, the zeta potential can be measured in accordance with the pH. Comparison of zeta potentials makes sense when they are compared under the same pH.

The preferred distribution width of the zeta potential of the composite particles of the silicone defoamer composition according to the present invention may vary in absolute value depending on the type of foaming liquid, the desired defoaming performance, and the like, but most generally, the distribution width has the following preferred range. That is, in the cumulative relative frequency distribution of the zeta potential measured, when the pH of the aqueous dispersion liquid to be measured is 7, using the laser Doppler electrophoresis method, it is preferable that the difference between the integral value of 10% and the integral value of 90% is 6 mV or more and 60 mV or less. If it is less than 6 mV, the initial defoaming property is not sufficient. If it exceeds 60 mV, it becomes difficult to achieve both the initial defoaming property and the defoaming persistence, and when the defoaming agent is in the emulsion form, the dispersion stability of the particles is lowered. More preferably, the difference is 10 mV or more and 40 mV or less.

As described above, the setting of the distribution width of the zeta potential of the composite particle of the silicone defoamer composition can selectively adopt the cases whether the initial defoaming property is regarded as important, whether both the initial defoaming property and the defoaming persistence are regarded as important, or whether the stability of the emulsion as a product is regarded as important, depending on the use applications. For example, these priorities may vary depending on the height tolerance of the foam and the shape of the container in which the foaming liquid is contained. As an example of the use application, when the waste liquid is accumulated in a narrow and deep pool and the waste liquid is frequently exchanged and the foam easily overflows, the initial defoaming property is regarded as important. When the foam hardly overflows because a wide and shallow pool is used, and when it is left for a long period of time, both the initial defoaming property and the defoaming persistence are required.

In addition, whether to mainly cause the foam-suppressing or to mainly cause the foam-breaking can also be selectively adopted to some extent depending on the use application. This is because the balance between the compositional heterogeneity and the morphological heterogeneity described above is set according to the use application. For example, in use applications where even little foam builds up is troublesome, the contribution of compositional heterogeneity may be increased in order to cause the foam-suppressing to occur mainly, while in use applications where foam buildup itself may occur, but may break at some stage of growth and not grow further, the contribution of morphological heterogeneity may be increased.

The silicone defoamer composition of the present invention and the method for producing the same effectively work in all processes involving foaming, such as in the chemical, food, petroleum, yarn making, textile, and pharmaceutical industries. In the product development and the product manufacturing of the defoamer having a large dependency on trial and error, the defoaming performance can be predicted by the present invention, and the defoamer having a high, stable defoaming performance, and the method for producing such a defoamer can be provided.

Furthermore, the silicone defoamer composition of the present invention can be expected to be capable of preparing the balance between the initial defoaming property and the defoaming persistence, and the balance between the defoaming performance and the dispersion stability, depending on the use application and the purpose. In addition, the silicone defoamer composition of the present invention can be expected to be capable of controlling which of the foam-suppressing and the foam-breaking is predominantly caused depending on the use application and the purpose.

### EXAMPLES

The present invention will now be described by way of examples. It should be noted that the present invention is not limited by these examples. The zeta potential measurement method, defoaming performance evaluation method, and dispersion stability evaluation in Examples and Comparative Examples were performed as follows.

In the performance evaluation test, a product with a failed result is described as a comparative example.

Dispersion was carried out using a surfactant to prepare an aqueous dispersion stock solution. The shear speed was set.

### <Method for Measuring Zeta Potential>

In order to measure a zeta potential of composite particles of a silicone defoamer composition, an aqueous dispersion liquid was prepared in which the concentration of the composite particles was set to fall within the range of 10 to 100 ppm in a neutral phosphate buffer solution diluted twice with ion-exchanged water. Silicone defoamer compositions, when in the compound form, were prepared by dispersing using a surfactant at a shear speed of 20,000 s−1, and, when in the emulsion form, were prepared by diluting with water or concentrating such that the concentration of the composite particles fall within a predetermined range. In either case, the pH of the aqueous dispersion liquid was adjusted to 7.

The zeta potential was measured by laser Doppler electrophoresis using a Malvern Nano-ZS90 machine. Measurements were performed at 25° C.

In the cumulative relative frequency distribution of the zeta potential, the difference between the integral value of 10% and the integral value of 90% was used as the distribution width of the zeta potential.

### <Dispersion Stability Evaluation Method>

In evaluating the dispersion stability of the composite particles of the silicone defoamer composition, an aqueous dispersion liquid was prepared in which the concentration of the composite particles was set to 1 mass % in ion-exchanged water. When the silicone defoamer composition was in the compound form, the composite particles were dispersed using a surfactant such as polyoxyethylene sorbitan fatty acid ester as appropriate. When the silicone defoamer composition was in the emulsion form, the emulsion was prepared by diluting the composition with water or concentrating it so that the concentration of the composite particles fell within a predetermined range.

The prepared aqueous dispersion liquid of 30 g was put into a 50-ml screw vial, and the presence of creaming and precipitation was confirmed after 1 month of storage at 25° C.

Evaluation criteria;
A: No creaming and no precipitation were confirmed, B: creaming and precipitation were slightly confirmed, C: creaming and precipitation were confirmed

The ranks A and B are considered as accepted products.

### <Defoaming Performance Evaluation Method>

A test foaming liquid was prepared by adding 1.5 mass % of a foaming liquid to ion-exchanged water and further adding a silicone defoamer composition. At this time, the concentration of the composite particles in the test foaming liquid was adjusted to 100 ppm. When the silicone defoamer composition was in the compound form, it was dispersed using a surfactant as appropriate.

One hundred milliliter of this test foaming liquid was placed in a 500-ml graduated cylinder having a diameter of 50 mm, and air was fed at a flow rate of 1.5 L/min. by an air pump using a Kinoshita glass ball filter 504G-1 to produce foam. The volume of the foam 10 seconds after the start of the air feeding was recorded and the initial defoaming property was evaluated.

As the foaming liquid, two types of foaming liquids including alkyl ether sulfate as a foaming liquid 1 and polyoxyethylene alkyl ether as a foaming liquid 2, respectively, were prepared and subjected to evaluation.

Evaluation criteria for initial defoaming property; The volume of foam after 10 seconds was rated with five stages as evaluation criteria. At least the evaluation rate of “3” shall be considered as an accepted product.

5: Less than 10 ml, 4: 10 ml or more and less than 100 ml, 3: 100 ml or more and less than 200 ml, 2: 200 ml or more and less than 300 ml, 1: 300 ml or more

In evaluating the defoaming persistence, after the evaluation of the initial defoaming property, the feeding of air was continued for 20 minutes under the same conditions in the same state, and the volume of foam at the point of 20 minutes was recorded, and the defoaming performance was evaluated by the same evaluation method as described above.

Evaluation criteria for defoaming persistence; The volume of foam after 20 minutes was rated with five stages as evaluation criteria. At least the evaluation rate of “3” shall be considered as an accepted product.

5: Less than 50 ml, 4: 50 ml or more and less than 200 ml, 3: 200 ml or more and less than 300 ml, 2: 300 ml or more, and foam stays in the cylinder, 1: foam overflows from the cylinder.

As for the overall evaluation of the defoaming performance, the case where both the initial defoaming property and the defoaming persistence were accepted shall be regarded as an accepted product.

### Example 1

In the following description, “parts” is based on mass, unless otherwise indicated. Also, the unit % indicates a ratio of corresponding siloxane units to the total number of siloxanes in all siloxanes.

One hundred parts of polydimethylsiloxane (referred to as silicone oil A) including 99.2% of (CH3)2SiO2/2 unit and 0.8% of (CH3)3SiO1/2 unit, in which 0.03% of all polydimethylsiloxane units has a silicon atom-modified ethoxy group, and 5.0 parts of hydrophilic fumed silica (referred to as silica 1) having a BET surface area of 200 m2/g were tightly mixed using a disk-type dissolver. This mixture was heated at 150° C. for 4 hours to prepare a compound.

The distribution width of the zeta potential for this compound was 18 mV.

The evaluation for dispersion stability was “A”.

In the evaluation for the initial defoaming property, air was fed into the foaming liquid 1 for 10 seconds, and the volume of foam was measured. The measured volume was 45 ml. Thus, the evaluation was “4”. In the foaming liquid 2, the volume after 10 seconds was 40 ml. Thus, the evaluation was “4”.

In the evaluation for the defoaming persistence in the foaming liquid 1, the volume of foam after 20 minutes had passed was 95 ml. Thus, the evaluation was “4”. In the foaming liquid 2, the volume after 20 minutes was 85 ml. Thus, the evaluation was “4”.

Table 1 shows the chemical composition as a silicone defoamer composition of the compound type, the measurement results of the distribution width of a zeta potential, dispersion stability, and defoaming property results.

Next, the above-described compound was dispersed by appropriately using polyoxyethylene sorbitan fatty acid ester to prepare an emulsion. The shear speed was 120,000 s−1. The distribution width of the zeta potential for the generated emulsion was 5.5 mV.

In the evaluation for the initial defoaming property, air was fed into the foaming liquid 1 for 10 seconds. The volume of foam measured at this time was 220 ml. Thus, the evaluation was “2” as being not accepted.

Then, the shear speed was changed to 20,000 s−1, and rework was performed.

The distribution width of the zeta potential for the generated emulsion was 17 mV.

The evaluation for the dispersion stability was “A”.

In the evaluation for the initial defoaming property, air was fed into the foaming liquid 1 for 10 seconds. The volume of foam measured at this time was 40 ml. Thus, the evaluation was “4”. In the foaming liquid 2, the volume after 10 seconds was 35 ml. Thus, the evaluation was “4”.

In the evaluation for the defoaming persistence in the foaming liquid 1, the volume of foam after 20 minutes had passed was 90 ml. Thus, the evaluation was “4”. In the foaming liquid 2, the volume after 20 minutes was 80 ml. Thus, the evaluation was “4”.

Table 2 shows the chemical composition as a silicone defoamer composition of the emulsion type, the measurement results of the distribution width of the zeta potential, dispersion stability, and defoaming property results. It is noted that the shear speed was that during the final rework, and the evaluation results of the dispersion stability and the defoaming property were obtained after the final rework.

### Example 2

A compound was produced in the same manner as that in Example 1 except that 50 parts by mass of the silicone oil A, and 50 parts by mass of polydimethylsiloxane (referred to as silicone oil B) including 99.7% of (CH3)2SiO2/2 unit and 0.3% of (CH3)3SiO1/2 unit, in which 0.03% of all polydimethylsiloxane units has a silicon atom-modified ethoxy group were used instead of 100 parts by mass of the silicone oil A in Example 1.

The distribution width of the zeta potential for this compound was 19 mV.

The evaluation for the dispersion stability was “A”.

In the evaluation for the initial defoaming property, air was fed into the foaming liquid 1 for 10 seconds, and the volume of foam measured at this time was 20 ml. Thus, the evaluation was “4”. In the foaming liquid 2, the volume after 10 seconds was 9 ml. Thus, the evaluation was “5”.

In the evaluation for the defoaming persistence in the foaming liquid 1, the volume of foam after 20 minutes had passed was 85 ml. Thus, the evaluation was “4”. In the foaming liquid 2, the volume after 20 minutes was 70 ml. Thus, the evaluation was “4”.

Next, an emulsion was produced in the same manner as that in Example 1 using the above-described compound. Then, the shear speed at the final rework was set to 20,000 s−1.

The distribution width of the zeta potential for the generated emulsion was 18 mV.

The evaluation for the dispersion stability was “A”.

In the evaluation for the initial defoaming property, air was fed into the foaming liquid 1 for 10 seconds. The volume of foam measured at this time was 20 ml. Thus, the evaluation was “4”. In the foaming liquid 2, the volume after 10 seconds was 15 ml. Thus, the evaluation was “4”.

In the evaluation for the defoaming persistence in the foaming liquid 1, the volume of foam after 20 minutes had passed was 70 ml. Thus, the evaluation was “4”. In the foaming liquid 2, the volume after 20 minutes was 65 ml. Thus, the evaluation was “4”.

### Example 3

A compound was produced in the same manner as that in Example 1 except that 70 parts by mass of the silicone oil A, and 30 parts by mass of isoparaffine as a mineral oil were used instead of 100 parts by mass of the silicone oil A in Example 1.

The distribution width of the zeta potential for this compound was 39 mV.

The evaluation for the dispersion stability was “A”.

In the evaluation for the initial defoaming property, air was fed into the foaming liquid 1 for 10 seconds, and the volume of foam was measured. The measured volume was 12 ml. Thus, the evaluation was “4”. In the foaming liquid 2, the volume after 10 seconds was 5 ml. Thus, the evaluation was “5”.

In the evaluation for the defoaming persistence in the foaming liquid 1, the volume of foam after 20 minutes had passed was 55 ml. Thus, the evaluation was “4”. In the foaming liquid 2, the volume after 20 minutes was 52 ml. Thus, the evaluation was “4”.

Next, an emulsion was produced in the same manner as that in Example 1 using the above-described compound. Then, the shear speed at the final rework was set to 20,000 s−1.

The distribution width of the zeta potential for the generated emulsion was 37 mV.

The evaluation for the dispersion stability was “A”.

In the evaluation for the initial defoaming property, air was fed into the foaming liquid 1 for 10 seconds, and the volume of foam measured at this time was 13 ml. Thus, the evaluation was “4”. In the foaming liquid 2, the volume after 10 seconds was 12 ml. Thus, the evaluation was “4”.

In the evaluation for the defoaming persistence in the foaming liquid 1, the volume of foam after 20 minutes had passed was 54 ml. Thus, the evaluation was “4”. In the foaming liquid 2, the volume after 20 minutes was 51 ml. Thus, the evaluation was “4”.

### Example 4

A compound was produced in the same manner as that in Example 1 except that 2.5 parts by mass of the silica 1 and 2.5 parts by mass of hydrophilic fumed silica (referred to as silica 2) having a BET surface area of 300 m2/g were used instead of 5.0 parts by mass of silica 1 in Example 1.

The distribution width of the zeta potential for this compound was 37 mV.

The evaluation for the dispersion stability was “A”.

In the evaluation for the initial defoaming property, air was fed into the foaming liquid 1 for 10 seconds, and the volume of foam was measured. The measured volume was 9 ml. Thus, the evaluation was “5”. In the foaming liquid 2, the volume after 10 seconds was 8 ml. Thus, the evaluation was “5”.

In the evaluation for the defoaming persistence in the foaming liquid 1, the volume of foam after 20 minutes had passed was 48 ml. Thus, the evaluation was “5”. In the foaming liquid 2, the volume after 20 minutes was 42 ml. Thus, the evaluation was “5”.

Next, an emulsion was produced in the same manner as that in Example 1 using the above-described compound. Then, the shear speed at the final rework was set to 20,000 s−1.

The distribution width of the zeta potential for the generated emulsion was 35 mV.

The evaluation for the dispersion stability was “A”.

In the evaluation for the initial defoaming property, air was fed into the foaming liquid 1 for 10 seconds, and the volume of foam measured at this time was 9 ml. Thus, the evaluation was “5”. In the foaming liquid 2, the volume after 10 seconds was 7 ml. Thus, the evaluation was “5”.

In the evaluation for the defoaming persistence in the foaming liquid 1, the volume of foam after 20 minutes had passed was 49 ml. Thus, the evaluation was “5”. In the foaming liquid 2, the volume after 20 minutes was 43 ml. Thus, the evaluation was “5”.

### Example 5

A compound was produced in the same manner as that in Example 1 except that, in Example 1, 50 parts by mass of the silicone oil A and 50 parts by mass of the silicone oil B were used instead of 100 parts by mass of the silicone oil A, and 2.5 parts by mass of the silica 1 and 2.5 parts by mass of the silica 2 were used instead of 5.0 parts by mass of silica 1.

The distribution width of the zeta potential for this compound was 39 mV.

The evaluation for the dispersion stability was “A”.

In the evaluation for the initial defoaming property, air was fed into the foaming liquid 1 for 10 seconds, and the volume of foam was measured. The measured volume was 9 ml. Thus, the evaluation was “5”. In the foaming liquid 2, the volume after 10 seconds was 8 ml. Thus, the evaluation was “5”.

In the evaluation for the defoaming persistence in the foaming liquid 1, the volume of foam after 20 minutes had passed was 55 ml. Thus, the evaluation was “4”. In the foaming liquid 2, the volume after 20 minutes was 52 ml. Thus, the evaluation was “4”.

Next, an emulsion was produced in the same manner as that in Example 1 using the above-described compound. Then, the shear speed at the final rework was set to 20,000 s−1.

The distribution width of the zeta potential for the generated emulsion was 37 mV.

The evaluation for the dispersion stability was “A”.

In the evaluation for the initial defoaming property, air was fed into the foaming liquid 1 for 10 seconds, and the volume of foam measured at this time was 8 ml. Thus, the evaluation was “5”. In the foaming liquid 2, the volume after 10 seconds was 8 ml. Thus, the evaluation was “5”.

In the evaluation for the defoaming persistence in the foaming liquid 1, the volume of foam after 20 minutes had passed was 54 ml. Thus, the evaluation was “4”. In the foaming liquid 2, the volume after 20 minutes was 53 ml. Thus, the evaluation was “4”.

### Example 6

A compound was produced in the same manner as that in Example 1 except that the silica 1 was used in an amount of 1.0 part by mass instead of 5.0 parts by mass in Example 1.

The distribution width of the zeta potential for this compound was 7 mV.

The evaluation for the dispersion stability was “A”.

In the evaluation for the initial defoaming property, air was fed into the foaming liquid 1 for 10 seconds, and the volume of foam was measured. The measured volume was 160 ml. Thus, the evaluation was “3”. In the foaming liquid 2, the volume after 10 seconds was 155 ml. Thus, the evaluation was “3”.

In the evaluation for the defoaming persistence in the foaming liquid 1, the volume of foam after 20 minutes had passed was 270 ml. Thus, the evaluation was “3”. In the foaming liquid 2, the volume after 20 minutes was 260 ml. Thus, the evaluation was “3”.

Next, an emulsion was produced in the same manner as that in Example 1 using the above-described compound. Then, the shear speed at the final rework was set to 20,000 s−1.

The distribution width of the zeta potential for the generated emulsion was 7 mV.

The evaluation for the dispersion stability was “A”.

In the evaluation for the initial defoaming property, air was fed into the foaming liquid 1 for 10 seconds, and the volume of foam measured at this time was 155 ml. Thus, the evaluation was “3”. In the foaming liquid 2, the volume after 10 seconds was 150 ml. Thus, the evaluation was “3”.

In the evaluation for the defoaming persistence in the foaming liquid 1, the volume of foam after 20 minutes had passed was 245 ml. Thus, the evaluation was “3”. In the foaming liquid 2, the volume after 20 minutes was 240 ml. Thus, the evaluation was “3”.

### Example 7

A compound was produced in the same manner as that in Example 1 except that the silica 1 was used in an amount of 30 parts by mass instead of 5.0 parts by mass in Example 1.

The distribution width of the zeta potential for this compound was 55 mV.

The evaluation for the dispersion stability was “B”.

In the evaluation for the initial defoaming property, air was fed into the foaming liquid 1 for 10 seconds, and the volume of foam was measured. The measured volume was 5 ml. Thus, the evaluation was “5”. In the foaming liquid 2, the volume after 10 seconds was 4 ml. Thus, the evaluation was “5”.

In the evaluation for the defoaming persistence in the foaming liquid 1, the volume of foam after 20 minutes had passed was 30 ml. Thus, the evaluation was “5”. In the foaming liquid 2, the volume after 20 minutes was 25 ml. Thus, the evaluation was “5”.

Next, an emulsion was produced in the same manner as that in Example 1 using the above-described compound. Then, the shear speed at the final rework was set to 20,000 s−1.

The distribution width of the zeta potential for the generated emulsion was 6 mV.

The evaluation for the dispersion stability was “B”.

In the evaluation for the initial defoaming property, air was fed into the foaming liquid 1 for 10 seconds, and the volume of foam measured at this time was 5 ml. Thus, the evaluation was “5”. In the foaming liquid 2, the volume after 10 seconds was 3 ml. Thus, the evaluation was “5”.

In the evaluation for the defoaming persistence in the foaming liquid 1, the volume of foam after 20 minutes had passed was 30 ml. Thus, the evaluation was “5”. In the foaming liquid 2, the volume after 20 minutes was 28 ml. Thus, the evaluation was “5”.

### Example 8

An emulsion was produced in the same manner as that in Example 1 using the compound produced in Example 1. Then, the shear speed at the final rework was set to 7,000 s−1.

The distribution width of the zeta potential for the generated emulsion was 25 mV.

The evaluation for the dispersion stability was “A”.

In the evaluation for the initial defoaming property, air was fed into the foaming liquid 1 for 10 seconds, and the volume of foam measured at this time was 9 ml. Thus, the evaluation was “5”. In the foaming liquid 2, the volume after 10 seconds was 8 ml. Thus, the evaluation was “5”.

In the evaluation for the defoaming persistence in the foaming liquid 1, the volume of foam after 20 minutes had passed was 75 ml. Thus, the evaluation was “4”. In the foaming liquid 2, the volume after 20 minutes was 60 ml. Thus, the evaluation was “4”.

### Example 9

An emulsion was produced in the same manner as that in Example 1 using the compound produced in Example 1. Then, the shear speed at the final rework was set to 50,000 s−1.

The distribution width of the zeta potential for the generated emulsion was 12 mV.

The evaluation for the dispersion stability was “A”.

In the evaluation for the initial defoaming property, air was fed into the foaming liquid 1 for 10 seconds, and the volume of foam measured at this time was 130 ml. Thus, the evaluation was “3”. In the foaming liquid 2, the volume after 10 seconds was 115 ml. Thus, the evaluation was “3”.

In the evaluation for the defoaming persistence in the foaming liquid 1, the volume of foam after 20 minutes had passed was 185 ml. Thus, the evaluation was “4”. In the foaming liquid 2, the volume after 20 minutes was 180 ml. Thus, the evaluation was “4”.

### Comparative Example 1

A compound was produced in the same manner as that in Example 1 except that the silica 1 was used in an amount of 0.2 parts by mass instead of 5.0 parts by mass in Example 1.

The distribution width of the zeta potential for this compound was 5 mV.

The evaluation for the dispersion stability was “A”.

In the evaluation for the initial defoaming property, air was fed into the foaming liquid 1 for 10 seconds, and the volume of foam was measured. The measured volume was 310 ml. Thus, the evaluation was “1”. In the foaming liquid 2, the volume after 10 seconds was 180 ml. Thus, the evaluation was “3”.

In the evaluation for the defoaming persistence in the foaming liquid 1, the foam after 20 minutes had passed overflowed the cylinder. Thus, the evaluation was “1”. In the foaming liquid 2, the volume after 20 minutes was 320 ml. Thus, the evaluation was “2”.

Next, an emulsion was produced in the same manner as that in Example 18 using the above-described compound. Then, the shear speed at the final rework was set to 20,000 s−1.

The distribution width of the zeta potential for the generated emulsion was 5 mV.

The evaluation for the dispersion stability was “A”.

In the evaluation for the initial defoaming property, air was fed into the foaming liquid 1 for 10 seconds, and the volume of foam measured at this time was 305 ml. Thus, the evaluation was “1”. In the foaming liquid 2, the volume after 10 seconds was 175 ml. Thus, the evaluation was “3”.

In the evaluation for the defoaming persistence in the foaming liquid 1, the foam after 20 minutes had passed overflowed the cylinder. Thus, the evaluation was “1”. In the foaming liquid 2, the volume after 20 minutes was 325 ml. Thus, the evaluation was “2”.

Therefore, in both the defoamer compositions in the compound form and the emulsion form, the initial defoaming property and the defoaming persistence were not acceptable for the foaming liquid 1.

In addition, in both the defoamer compositions in the compound form and the emulsion form, the initial defoaming property was acceptable, but the defoaming persistence was not acceptable for the foaming liquid 2.

### Comparative Example 2

A compound was produced in the same manner as that in Example 1 except that the silica 1 was used in an amount of 50 parts by mass instead of 5.0 parts by mass in Example 1.

The distribution width of the zeta potential for this compound was 70 mV.

The evaluation for the dispersion stability was “C”.

In the evaluation for the initial defoaming property, air was fed into the foaming liquid 1 for 10 seconds, and the volume of foam was measured. The measured volume was 7 ml. Thus, the evaluation was “5”. In the foaming liquid 2, the volume after 10 seconds was 6 ml. Thus, the evaluation was “5”.

In the evaluation for the defoaming persistence in the foaming liquid 1, the foam after 20 minutes had passed overflowed the cylinder. Thus, the evaluation was “1”. In the foaming liquid 2, the foam after 20 minutes overflowed the cylinder. Thus, the evaluation was “1”.

Next, an emulsion was produced in the same manner as that in Example 1 using the above-described compound. Then, the shear speed at the final rework was set to 20,000 s−1.

The distribution width of the zeta potential for the generated emulsion was 67 mV.

The evaluation for the dispersion stability was “C”.

In the evaluation for the initial defoaming property, air was fed into the foaming liquid 1 for 10 seconds, and the volume of foam measured at this time was 7 ml. Thus, the evaluation was “5”. In the foaming liquid 2, the volume after 10 seconds was 7 ml. Thus, the evaluation was “5”.

In the evaluation for the defoaming persistence in the foaming liquid 1, the foam after 20 minutes had passed overflowed the cylinder. Thus, the evaluation was “1”. In the foaming liquid 2, the foam after 20 minutes overflowed the cylinder. Thus, the evaluation was “1”.

Therefore, in both the defoamer compositions in the compound form and the emulsion form, the initial defoaming property was acceptable, but the defoaming persistence was not acceptable, for both the foaming liquid 1 and the foaming liquid 2.

### Comparative Example 3

A compound was produced in the same manner as that in Example 1 except that 35 parts by mass of the silicone oil A, 35 parts by mass of the silicone oil B, and 30 parts by mass of iso-paraffin as a mineral oil were used instead of 100 parts by mass of the silicone oil A in Example 1.

The distribution width of the zeta potential for this compound was 65 mV.

The evaluation for the dispersion stability was “C”.

In the evaluation for the initial defoaming property, air was fed into the foaming liquid 1 for 10 seconds, and the volume of foam was measured. The measured volume was 9 ml. Thus, the evaluation was “5”. In the foaming liquid 2, the volume after 10 seconds was 8 ml. Thus, the evaluation was “5”.

In the evaluation for the defoaming persistence in the foaming liquid 1, the volume of foam after 20 minutes had passed was 330 ml. Thus, the evaluation was “2”. In the foaming liquid 2, the volume after 20 minutes was 315 ml. Thus, the evaluation was “2”.

Next, an emulsion was produced in the same manner as that in Example 1 using the above-described compound. Then, the shear speed at the final rework was set to 20,000 s−1.

The distribution width of the zeta potential for the generated emulsion was 64 mV.

The evaluation for the dispersion stability was “C”.

In the evaluation for the initial defoaming property, air was fed into the foaming liquid 1 for 10 seconds, and the volume of foam measured at this time was 9 ml. Thus, the evaluation was “5”. In the foaming liquid 2, the volume after 10 seconds was 8 ml. Thus, the evaluation was “5”.

In the evaluation for the defoaming persistence in the foaming liquid 1, the volume of foam after 20 minutes had passed was 325 ml. Thus, the evaluation was “2”. In the foaming liquid 2, the volume after 20 minutes was 310 ml. Thus, the evaluation was “2”.

Thus, in both the defoamer compositions in the compound form and the emulsion form, the initial defoaming property was acceptable, but the defoaming persistence was not acceptable, for both the foaming liquid 1 and the foaming liquid 2.

### Comparative Example 4

An emulsion was produced in the same manner as that in Example 1 using the compound produced in Example 1. Then, the shear speed at the final rework was set to 3,000 s−1.

The distribution width of the zeta potential for the generated emulsion was 55 mV.

The evaluation for the dispersion stability was “C”.

In the evaluation for the initial defoaming property, air was fed into the foaming liquid 1 for 10 seconds, and the volume of foam measured at this time was 9 ml. Thus, the evaluation was “5”. In the foaming liquid 2, the volume after 10 seconds was 8 ml. Thus, the evaluation was “5”.

In the evaluation for the defoaming persistence in the foaming liquid 1, the foam after 20 minutes had passed overflowed the cylinder. Thus, the evaluation was “1”. In the foaming liquid 2, the volume of foam after 20 minutes was 290 ml. Thus, the evaluation was “3”.

Thus, the initial defoaming property was acceptable, but the defoaming persistence was not acceptable for the foaming liquid 1. Both the initial defoaming property and the defoaming persistence were acceptable for the foaming liquid 2.

### Comparative Example 5

An emulsion was produced in the same manner as that in Example 1 using the compound produced in Example 1. Then, the shear speed at the final rework was set to 150,000 s−1.

The distribution width of the zeta potential for the generated emulsion was 6 mV.

The evaluation for the dispersion stability was “A”.

In the evaluation for the initial defoaming property, air was fed into the foaming liquid 1 for 10 seconds, and the volume of foam measured at this time was 210 ml. Thus, the evaluation was “2”. In the foaming liquid 2, the volume after 10 seconds was 195 ml. Thus, the evaluation was “3”.

In the evaluation for the defoaming persistence in the foaming liquid 1, the volume of foam after 20 minutes had passed was 305 ml. Thus, the evaluation was “2”. In the foaming liquid 2, the volume after 20 minutes was 275 ml. Thus, the evaluation was “3”.

Thus, both the initial defoaming property and the defoaming persistence were not acceptable for the foaming liquid 1. Both the initial defoaming property and the defoaming persistence were acceptable for the foaming liquid 2.

TABLE 1

| | | | | | | | | | | Comp. | Comp. | Comp. |
|---|---|---|---|---|---|---|---|---|---|---|---|---|
| <Compound type> | | | Ex. 1 | Ex. 2 | Ex. 3 | Ex. 4 | Ex. 5 | Ex. 6 | Ex. 7 | Ex. 1 | Ex. 2 | Ex. 3 |
| Mass | Silicone | Silicone | 100 | 50 | 70 | 100 | 50 | 100 | 100 | 100 | 100 | 35 |
| parts | oil | oil A | | | | | | | | | | |
| | | Silicone | — | 50 | — | — | 50 | — | — | — | — | 35 |
| | | oil B | | | | | | | | | | |
| | Organic | Mineral | — | — | 30 | — | — | — | — | — | — | 30 |
| | oil | oil | | | | | | | | | | |
| | Silica | Silica 1 | 5.0 | 5.0 | 5.0 | 2.5 | 2.5 | 1.0 | 30 | 0.2 | 50 | 5.0 |
| | | Silica 2 | — | — | — | 2.5 | 2.5 | — | — | — | — | — |

| Silica content (mass % to oil) | | 5.0 | 5.0 | 5.0 | 5.0 | 5.0 | 1.0 | 30 | 0.2 | 50 | 5.0 |
|---|---|---|---|---|---|---|---|---|---|---|---|
| Zeta potential distribution width (mV) | | 18 | 19 | 39 | 37 | 39 | 7 | 54 | 5 | 70 | 65 |
| Dispersion stability¹⁾ | | A | A | A | A | A | A | B | A | C | C |
| Foaming | Defoaming property | 4 | 4 | 4 | 5 | 5 | 3 | 5 | 1 | 5 | 5 |
| liquid 1 | after 10 seconds²⁾ | | | | | | | | | | |
| | Defoaming property | 4 | 4 | 4 | 5 | 4 | 3 | 5 | 1 | 1 | 2 |
| | after 20 minutes³⁾ | | | | | | | | | | |
| Foaming | Defoaming property | 4 | 5 | 5 | 5 | 5 | 3 | 5 | 3 | 5 | 5 |
| liquid 2 | after 10 seconds²⁾ | | | | | | | | | | |
| | Defoaming property | 4 | 4 | 4 | 5 | 4 | 3 | 5 | 2 | 1 | 2 |
| | after 20 minutes³⁾ | | | | | | | | | | |

¹⁾1% aqueous dispersion, 25° C./after one month, A: No creaming and no precipitation were confirmed, B: creaming and precipitation were slightly confirmed, C: creaming and precipitation were confirmed (The ranks A and B are considered as accepted products.)
²⁾Initial deforming property evaluation, Three or higher ranked product is accepted.
³⁾Deforming persistence evaluation, Three or higher ranked product is accepted.

TABLE 2

| Emulsion type | | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|---|
| Mass | Silicone | Silicone | 100 | 50 | 70 | 100 | 50 | 100 | 100 | 100 | 100 |
| parts | oil | oil A | | | | | | | | | |
| | | Silicone | — | 50 | — | — | 50 | — | — | — | — |
| | | oil B | | | | | | | | | |
| | Organic | Mineral | — | — | 30 | — | — | — | — | — | — |
| | oil | oil | | | | | | | | | |
| | Silica | Silica 1 | 5.0 | 5.0 | 5.0 | 2.5 | 2.5 | 1.0 | 30 | 5.0 | 5.0 |
| | | Silica 2 | — | — | — | — | 2.5 | — | — | — | — |

| Silica content (mass % to oil) | | 5.0 | 5.0 | 5.0 | 5.0 | 5.0 | 1.0 | 30 | 5.0 | 5.0 |
|---|---|---|---|---|---|---|---|---|---|---|
| Shear speed (s⁻¹) | | 20,000 | 20,000 | 20,000 | 20,000 | 20,000 | 20,000 | 20,000 | 7,000 | 50,000 |
| during production of emulsion | | | | | | | | | | |
| (during final rework) | | | | | | | | | | |
| Zeta potential distribution | | 17 | 18 | 37 | 35 | 37 | 7 | 53 | 25 | 12 |
| width (mV) | | | | | | | | | | |
| Dispersion stability¹⁾ | | A | A | A | A | A | A | B | A | A |
| Foaming | Defoaming property | 4 | 4 | 4 | 5 | 5 | 3 | 5 | 5 | 3 |
| liquid 1 | after 10 seconds²⁾ | | | | | | | | | |
| | Defoaming property | 4 | 4 | 4 | 5 | 4 | 3 | 5 | 4 | 4 |
| | after 20 minutes³⁾ | | | | | | | | | |
| Foaming | Defoaming property | 4 | 4 | 4 | 5 | 5 | 3 | 5 | 5 | 3 |
| liquid 2 | after 10 seconds²⁾ | | | | | | | | | |
| | Defoaming property | 4 | 4 | 4 | 5 | 4 | 3 | 5 | 4 | 4 |
| | after 20 minutes³⁾ | | | | | | | | | |

| | | | Comp. | Comp. | Comp. | Comp. | Comp. |
|---|---|---|---|---|---|---|---|
| Emulsion type | | | Ex. 1 | Ex. 2 | Ex. 3 | Ex. 4 | Ex. 5 |
| Mass | Silicone | Silicone | 100 | 100 | 35 | 100 | 100 |
| parts | oil | oil A | | | | | |
| | | Silicone | — | — | 35 | — | — |
| | | oil B | | | | | |
| | Organic | Mineral | — | — | 30 | — | — |
| | oil | oil | | | | | |
| | Silica | Silica 1 | 0.2 | 50 | 5.0 | 5.0 | 5.0 |
| | | Silica 2 | — | — | — | — | — |

| Silica content (mass % to oil) | | 0.2 | 50 | 5.0 | 5.0 | 5.0 |
|---|---|---|---|---|---|---|
| Shear speed (s⁻¹) | | 20,000 | 20,000 | 20,000 | 3,000 | 150,000 |
| during production of emulsion | | | | | | |
| (during final rework) | | | | | | |
| Zeta potential distribution | | 5 | 67 | 64 | 55 | 6 |
| width (mV) | | | | | | |
| Dispersion stability¹⁾ | | A | C | C | C | A |
| Foaming | Defoaming property | 1 | 5 | 5 | 5 | 2 |
| liquid 1 | after 10 seconds²⁾ | | | | | |
| | Defoaming property | 1 | 1 | 2 | 1 | 2 |
| | after 20 minutes³⁾ | | | | | |
| Foaming | Defoaming property | 3 | 5 | 5 | 5 | 3 |
| liquid 2 | after 10 seconds²⁾ | | | | | |
| | Defoaming property | 2 | 1 | 2 | 3 | 3 |
| | after 20 minutes³⁾ | | | | | |

¹⁾1% aqueous dispersion, 25° C./after one month, A: No creaming and no precipitation were confirmed, B: creaming and precipitation were slightly confirmed, C: creaming and precipitation were confirmed (The ranks A and B are considered as accepted products.)
²⁾Initial deforming property evaluation, Three or higher ranked product is accepted.
³⁾Deforming persistence evaluation, Three or higher ranked product is accepted.

As apparent from Examples and Comparative Examples in Tables 1 and 2, the distribution width of the zeta potential of the composite particles of the silicone defoamer composition tended to be wider as the number of the types of the oil and/or silica is more. Moreover, it became wider as the mass % of the silica with respect to the oil was larger. Moreover, it became wider as the shear speed at the time of production of the emulsion was smaller.

In Comparative Example 1 in which the zeta potential was 5 mV, the comprehensive evaluation of the defoaming property was not accepted in both of the foaming liquid 1 and the foaming liquid 2. In Comparative Example 5 in which the zeta potential was 6 mV, although the comprehensive evaluation of defoaming properties was not accepted in the foaming liquid 1, it was accepted in the foaming liquid 2. Therefore, in Example 6 in which the zeta potential was 7 mV, the comprehensive evaluation of the defoaming properties was accepted in both of the foaming liquid 1 and the foaming liquid 2.

Therefore, it has been found that the lower limit of the threshold of the distribution width of the zeta potential of the composite particles of the silicone defoamer composition exists between 6 mV and 7 mV for the foaming liquid 1 and between 5 mV and 6 mV for the foaming liquid 2.

Similarly, it has been found that from the results of Example 7, Comparative Example 4, and Comparative Example 3 that the upper limit of the threshold of the distribution width of the zeta potential exists between 54 mV and 55 mV for the foaming liquid 1 and between 55 mV and 64 mV for the foaming liquid 2.

Thus, the difference of the suitable range of the distribution width of the zeta potential depending on the foaming liquid used was shown.

However, when the distribution width of the zeta potential exceeds 50 mV, the defoaming persistence tends to decrease, and the dispersion stability of the composite particles also decreases.

### INDUSTRIAL APPLICABILITY

The silicone defoamer composition of the present invention and the method for producing the same effectively work in all processes involving foaming, such as in the chemical, food, petroleum, yarn making, textile, and pharmaceutical industries. As the product development and the product manufacturing of the defoamer having a large dependency on trial and error, the defoaming performance can be predicted by the present invention, and the defoamer having a high, stable defoaming performance, and a method for producing such a defoamer can be provided. Furthermore, it is expected that the balance between the initial defoaming property and the defoaming persistence, and the balance between the defoaming performance and the dispersion stability can be adjusted depending on the use application and the purpose. In addition, the silicone defoamer composition of the present invention can be expected to be capable of controlling which of the foam-suppressing and the foam-breaking is predominantly caused depending on the use application and the purpose.

1-7. (canceled)

8. A silicone defoamer composition of a type which defoams by being previously added to a foaming liquid, the silicone defoamer composition comprising a composite particle group of an oil containing silicone as an essential component and silica, wherein
a distribution width of a zeta potential of the composite particle group is set, characterized in that,
the cumulative relative frequency distribution of the zeta potential of the composite particles of the silicone defoamer composition showing a difference of 6 mV or more and 60 mV or less between the integral value of 10% and the integral value of 90%,
measured by laser Doppler electrophoresis method, of an aqueous dispersion liquid having a pH of 7,
wherein said aqueous dispersion liquid is the silicone defoamer composition aqueous dispersion, which is diluted or concentrated with water so that the composite particle concentration is 10 ppm or more and 50,000 ppm or less.

9. A method for producing a silicone defoamer composition of a type which defoams by being previously added to a foaming liquid, comprising:
a stage of selecting a type and/or an amount for each of an oil component and a silica component depending on a type of a foaming liquid;
a stage of mixing the selected oil component and silica component to prepare a silicone defoamer composition including a composite particle group of an oil containing silicone as an essential component and silica;
a stage of obtaining a sample of the silicone defoamer composition generated and measuring a distribution width of a zeta potential of the composite particle group; and
repeating the selecting stage and/or the adjusting stage, and the measuring stage until the measured distribution width of a zeta potential becomes a threshold value or more which is set, characterized in that,
the cumulative relative frequency distribution of the zeta potential of the composite particles of the silicone defoamer composition showing a difference of 6 mV or more and 60 mV or less between the integral value of 10% and the integral value of 90%,
measured by laser Doppler electrophoresis method, of the aqueous dispersion liquid having a pH of 7,
wherein said aqueous dispersion liquid is the silicone defoamer composition aqueous dispersion, which is diluted or concentrated with water so that the composite particle concentration is 10 ppm or more and 50,000 ppm or less.

10. The method for producing a silicone defoamer composition according to claim 9, wherein, when the silicone defoamer composition is in a form of a compound, the zeta potential is measured while the silicone defoamer composition is in a state of a water dispersion, and when the composition is in a form of an emulsion, the silicone defoamer composition is prepared by shearing at a predetermined shear speed during production of the emulsion and the zeta potential thereof is measured in the form of emulsion.

11. The method for producing a silicone defoamer composition according to claim 9, wherein the distribution width of the zeta potential is set to a predetermined value or less so that the silicone defoamer composition previously added to the foaming liquid is maintained in a dispersed state in the forming liquid, and the composite particles of the silicone defoamer composition are maintained in a dispersed state.

12. The method for producing a silicone defoamer composition according to claim 9, wherein in the adjusting stage, the shear speed is selected depending on the types and/or amount of the oil component containing silicone as an essential component and the silica component selected in the selecting stage.

13. The method for producing a silicone defoamer composition according to claim 9, wherein the stage of measuring the distribution width of the zeta potential includes a stage of making the silicone defoamer composition to be sampled have a predetermined solid concentration.

14. The method for producing a silicone defoamer composition according to claim 9, wherein the predetermined shear speed in the preparing stage is set depending on a silicone amount/a silica amount set in the selecting stage.
